(19) United States
(12) Patent Application Publication
(10) Pub. No.: US 2026/0126665 A1
(43) Pub. Date: May 7, 2026

(54) HEAD-MOUNTED ELECTRONIC DEVICE AND CHARGING METHOD THEREFOR

(71) Applicant: SAMSUNG ELECTRONICS CO., LTD., Suwon-si (KR)

(72) Inventors: Wook KIM, Suwon-si (KR); Jongmin YOON, Suwon-si (KR); Jinchoul LEE, Suwon-si (KR)

(21) Appl. No.: 19/430,600

(22) Filed: Dec. 23, 2025

Related U.S. Application Data
(63) Continuation of application No. PCT/KR2024/007460, filed on May 31, 2024.

(30) Foreign Application Priority Data
Jun. 26, 2023 (KR) 10-2023-0082170
Aug. 17, 2023 (KR) 10-2023-0107792

(51) Int. Cl. G02B 27/01; G02C 11/00

(52) U.S. Cl. CPC G02B 27/0176; G02C 11/10; G02B 2027/0178

(57) ABSTRACT

An electronic device includes a battery, a charging terminal, and a power management circuit which receives power and charges the battery. The electronic device further includes a first charging line for connecting the charging terminal and the power management circuit, a second charging line for connecting the power management circuit and the battery, and a signal line of at least one electrical component. The electronic device further includes a first switch for switching the at least one electrical component and the first charging line or a second charging line, at a first end of the signal line, a second switch for switching the at least one electrical component and the first charging line or the second charging line, at a second end of the signal line, and a processor operatively connected to the power management circuit, the at least one electrical component, the first switch, and the second switch.

### TECHNICAL FIELD

Various embodiments disclosed herein relate to an electronic device and, for example, to a method for charging a battery in an electronic device.

### BACKGROUND ART

Augmented reality (AR) is a technology that combines real-world space with virtual space to make virtual objects appear as if the virtual objects exist in the real-world space. Augmented reality may be derived from virtual reality, which uses computer graphics to generate virtual spaces resembling the real world.

Recently, wearable electronic devices that may be directly worn on the body have been developed as electronic devices for providing augmented reality or virtual reality services (hereinafter, referred to as AR devices). For example, wearable electronic devices for providing augmented reality or virtual reality may include a head-mounted device (HMD), a head-mounted display (HMD), or AR glasses, and hereinafter, will be referred to as AR devices.

The above information may be provided as related art to aid in understanding the disclosure. No claim or determination is made as to whether any of the above content may be applied as prior art related to the disclosure.

### DISCLOSURE OF INVENTION

### Solution to Problem

An electronic device according to an embodiment may include a battery, a charging terminal, a power management circuit configured to receive a current and charge the battery, a first charging line configured to connect the charging terminal to the power management circuit, and a second charging line configured to connect the power management circuit to the battery.

The electronic device according to an embodiment may include a signal line of at least one electrical component, a first switch configured to switch the at least one electrical component and the first charging line or the second charging line at a first end of the signal line, a second switch configured to switch the at least one electrical component and the first charging line or the second charging line at a second end of the signal line, and a processor operatively connected to the power management circuit, the at least one electrical component, the first switch, and the second switch.

According to an embodiment, the processor may be configured to switch the first switch and the second switch during charging of the battery to supply a current from the charging terminal to the battery via the first charging line or the second charging line and the signal line.

According to an embodiment, a method for an electronic device, including at least one electrical component, a charging terminal, a power management circuit, and a battery, may include identifying an operating state of the electronic device and determining a charging mode of the electronic device.

According to an embodiment, the method for the electronic device may include using the signal line as a charging line between the charging terminal, the power management circuit, and the battery based on the charging mode to perform charging of the battery via the signal line together with the charging line, or using the signal line as a normal signal line to perform charging via the charging line.

According to an embodiment, a computer-readable recording medium storing one or more computer programs may include instructions for performing the method by a processor.

For AR devices, charging wiring is designed based on the positions of the battery and the charging terminal, and charging efficiency may decrease as various wires are placed within a limited housing.

AR devices consume high power during operation, resulting in short usage times, thus requiring a design that considers charging efficiency for high-power charging.

The technical problems, features, and effects to be achieved by the disclosure are not limited to those mentioned above. Other technical problems, features, and effects not mentioned will be clearly understood by those skilled in the art to which the disclosure belongs from the following description.

### BRIEF DESCRIPTION OF DRAWING

With regard to the description of the drawings, identical or similar reference numerals may be used for identical or similar elements.

FIG. 1 is a block diagram of an electronic device within a network environment according to various embodiments.

FIG. 2A illustrates an overall configuration of an electronic device according to various embodiments.

FIG. 2B illustrates a front view of an electronic device according to various embodiments.

FIG. 2C illustrates a rear view of an electronic device according to various embodiments.

FIG. 3 is a block diagram of an electronic device according to various embodiments.

FIGS. 4A, 4B, and 4C illustrate examples of charging wiring of an electronic device according to various embodiments.

FIG. 5 illustrates an example of charging wiring of an electronic device according to an embodiment.

FIG. 6 a flowchart illustrating charging operation of an electronic device according to various embodiments.

FIG. 7 illustrates an example of a switching operation in a charging operation of an electronic device according to an embodiment.

FIG. 8 illustrates an example of a switching operation in a charging operation of an electronic device according to an embodiment.

FIG. 9 illustrates a heat generation phenomenon due to a charging operation of an electronic device according to various embodiments.

### MODE FOR THE INVENTION

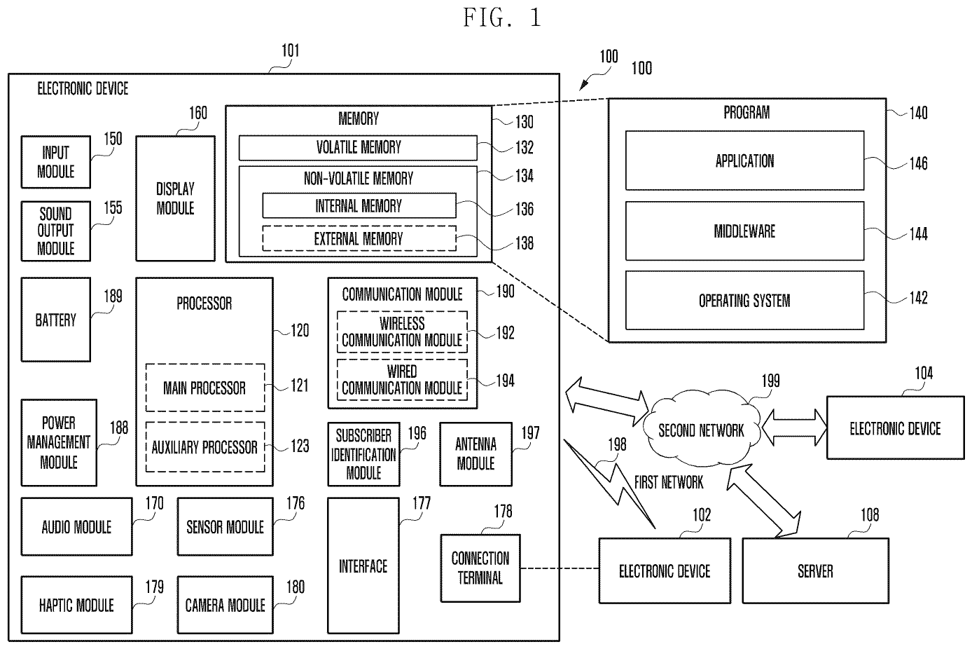

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

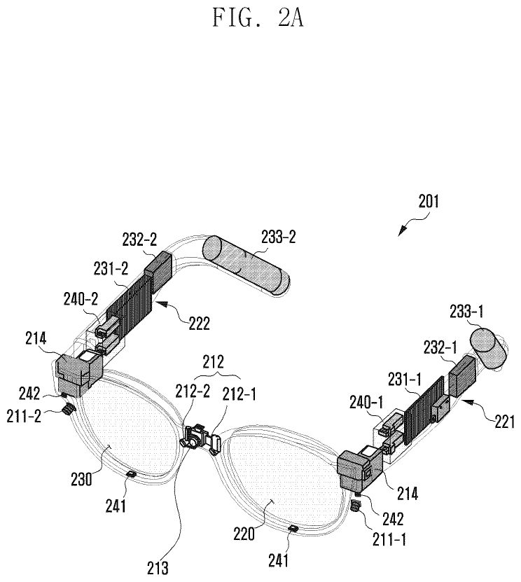

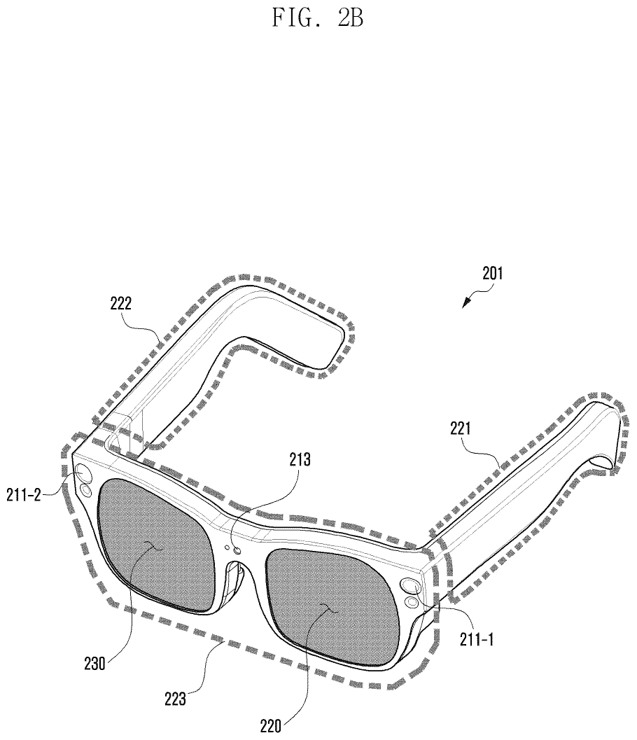

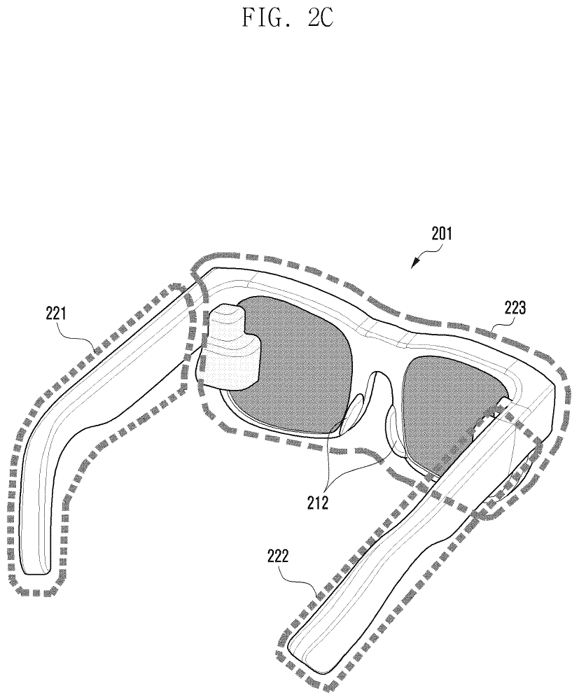

FIG. 2A illustrates an overall configuration of an AR device according to various embodiments. FIG. 2B illustrates a front view of an AR device according to various embodiments. FIG. 2C illustrates a rear view of an AR device according to various embodiments. FIG. 2B is a first exemplary view illustrating the front portion of an AR device 201, and FIG. 2C is a second exemplary view illustrating the rear portion of the AR device 201, wherein the internal configuration may be the same as that illustrated in FIG. 2A.

In various embodiments, the AR device 201 is a head-mounted electronic device that is to be worn on a user's head, and may provide the user with images related to augmented reality services. According to an embodiment, the AR device 201 may provide an augmented reality service that outputs at least one virtual object to be superimposed in an area determined as the user's field of view (FoV). For example, the area determined as the user's field of view is an area that is determined to be recognizable by the user wearing the AR device 201 through the AR device 201, and may be an area encompassing all or at least a portion of a display module (e.g., the display module 160 in FIG. 1) of the AR device 201. According to an embodiment, the AR device 201 may include multiple sheets of glass (e.g., first glass 220 and/or second glass 230) corresponding to each of the user's eyes (e.g., the left eye and/or the right eye). The multiple sheets of glass may include at least a portion of the display module (e.g., the display module 160 in FIG. 1). For example, the first glass 220 corresponding to the user's left eye may include a first display module 428-1, and the second glass 230 corresponding to the user's right eye may include a second display module 428-2. For example, the AR device 201 may be configured as a head-mounted electronic device. The head-mounted electronic device may be configured in various forms such as glasses, goggles, a helmet, or a hat, but the disclosure is not limited thereto.

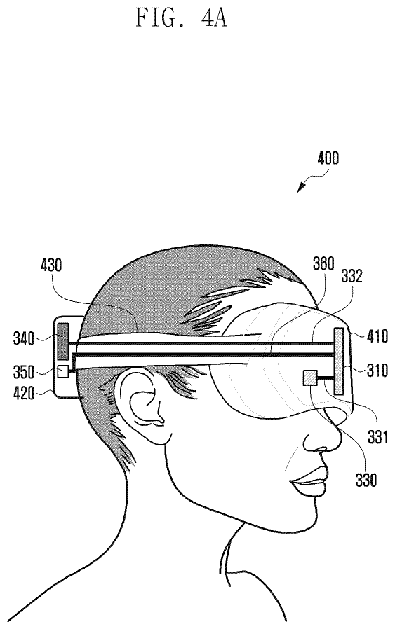

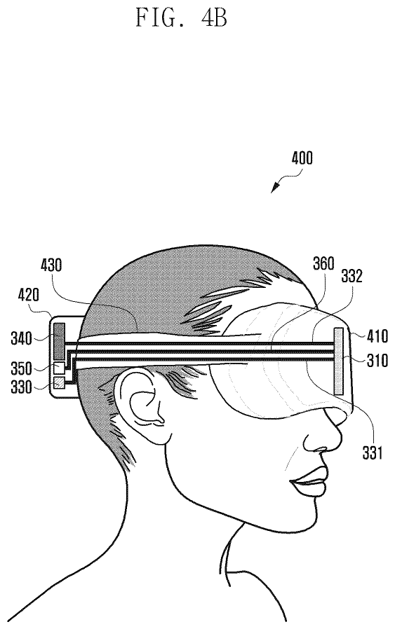

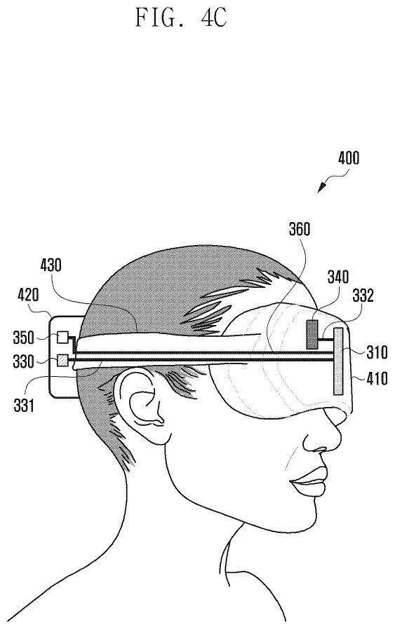

Referring to FIG. 2A, the AR device 201 according to an embodiment may include a display module 214, camera modules 211-1, 211-2, 212, and 213, audio modules 232-1 and 232-2, a first support 221, and/or a second support 222. According to an embodiment, the display module 214 may include a first display (e.g., the first glass 220) (e.g., a first display module 428-1 in FIG. 4) and/or a second display (e.g., the second glass 230) (e.g., a second display module 428-2 in FIG. 4). According to an embodiment, at least one camera may include an imaging camera 213 for capturing an image corresponding to the user's field of view (FoV) and/or measuring the distance to an object, an eye-tracking camera 212 for identifying the direction of the user's gaze, and/or recognition cameras (gesture cameras) 211-1 and 211-2 for recognizing a specific space. For example, the imaging camera 213 may capture an image in the forward direction of the AR device 201, and the eye-tracking camera 212 may capture an image in a direction opposite to the imaging direction of the imaging camera 213. For example, the eye-tracking camera 212 may capture an image of at least a portion of the user's eyes. According to an embodiment, the first support 221 and/or the second support 222 may include printed circuit boards (PCBs) 231-1 and 231-2, speakers 232-1 and 232-2, and/or batteries 233-1 and 233-2.

According to an embodiment, the display module (e.g., the display module 214 in FIG. 2A) may be disposed on a body (e.g., the body 223 in FIG. 2B) of the AR device 201, and the glass (e.g., the first glass 220 and the second glass 230) may include a condenser lens (not shown) and/or a transparent waveguide (not shown). For example, the transparent waveguide may be at least partially located within a portion of the glass. According to an embodiment, light emitted from the display module 214 may be incident onto one end of the glass through the first glass 220 and the second glass 230, and the incident light may be transmitted to the user through waveguides and/or waveguide paths (e.g., waveguides) formed within the glass. The waveguide may be made of glass, plastic, or polymer and may include a nano-pattern formed on an inner or outer surface, such as a grating structure with a polygonal or curved shape. According to an embodiment, the incident light may propagate or reflect within the waveguide due to the nano-pattern and may be provided to the user. According to an embodiment, the waveguide path (waveguide) may include at least one among at least one diffractive element (e.g., a diffractive optical element (DOE), a holographic optical element (HOE)) or reflective element (e.g., a reflective mirror). According to an embodiment, the waveguide path may guide display light emitted from a light source to the user's eyes by using the at least one diffractive element or reflective element.

Referring to FIG. 2A, the first support 221 and/or the second support 222 may include printed circuit boards 231-1 and 231-2 for transmitting electrical signals to each component of the AR device 201, speakers 232-1 and 232-2 for outputting audio signals (e.g., a data signal), batteries 233-1 and 233-2, and/or hinges 240-1 and 240-2 at least partially coupled to the body 223 of the AR device 201. According to an embodiment, the speakers 232-1 and 232-2 may include a first speaker 232-1 for delivering an audio signal (e.g. a data signal) to the user's left ear and a second speaker 232-2 for delivering an audio signal (e.g., data signal) to the user's right ear. According to an embodiment, the AR device 201 may be provided with multiple batteries 233-1 and 233-2 and may supply power to the printed circuit boards 231-1 and 231-2 via a power management module.

Referring to FIG. 2A, the AR device 201 may include a microphone 241 for receiving the user's voice and ambient sounds. The AR device 201 may include at least one illumination LED 242 to enhance the accuracy of at least one camera (e.g., the imaging camera 213, the eye-tracking camera 212, and/or the recognition cameras 211-1 and 211-2). For example, the illumination LED 242 may be used as an auxiliary device for enhancing accuracy when the eye-tracking camera 212 captures an image of the user's pupils, and the illumination LED 242 may use an IR LED with an infrared wavelength rather than a visible light wavelength. In another example, the illumination LED 242 may be used as an auxiliary device when capturing an image of the user's gesture with the recognition cameras 211-1 and 211-2, particularly when detecting a subject, the image of which is to be captured, is difficult due to dark environments or the presence of multiple light sources and reflected light.

Referring to FIGS. 2B and 2C, an AR device 201 according to an embodiment may include a body 223 and supports (e.g., the first support 221 and/or the second support 222), and the body 223 and the supports 221 and 222 may be operatively connected. For example, the body 223 and the supports 221 and 222 may be operatively connected via hinges 240-1 and 240-2. The body 223 may be at least partially mounted on the user's nose and may include a display module and a camera module. The supports 221 and 222 may include support members that are mounted on the user's ears, and may include a first support 221 that is mounted on the left ear and/or a second support 222 that is mounted on the right ear. According to an embodiment, the first support 221 or the second support 222 may include at least partially printed circuit board 231-1 and 231-2, speakers 232-1 and 232-2, and/or batteries 233-1 and 233-2. The batteries may be electrically connected to a power management module.

According to an embodiment, the display module may include first glass 220 and/or second glass 230, and may provide visual information to the user via the first glass 220 and the second glass 230. The AR device 201 may include the first glass 220 corresponding to the left eye and/or the second glass 230 corresponding to the right eye. According to an embodiment, the display module may include a display panel and/or a lens (e.g., glass). For example, the display panel may include a transparent material such as glass or plastic.

According to an embodiment, the display module may be formed of transparent element, allowing the user to recognize a real space behind the display module by looking through the display module. The display module may display a virtual object on at least a portion of the transparent element so that the user recognizes the virtual object as being superimposed on at least a portion of the real space. The first glass 220 and/or the second glass 230 included in the display module may include multiple display panels corresponding to the user's eyes (e.g., the left eye and/or the right eye).

According to an embodiment, the AR device 201 may include a virtual reality (VR) device (e.g., a virtual reality device). When the AR device 201 is a VR device, the first glass 220 may be a first display module, and the second glass 230 may be a second display module.

According to an embodiment, the virtual object output by the display module may include information related to an application program running on the AR device 201 and/or information related to an external object located in the real space corresponding to an area determined as the user's field of view (FoV). For example, the AR device 201 may identify an external object included in at least a portion of image information related to the real space, acquired through a camera (e.g., the imaging camera 213) of the AR device 201, wherein the at least portion of the image information corresponds to the area determined as the user's field of view (FoV). The AR device 201 may output (or display) a virtual object related to the external object identified in the at least portion of the image information through the area determined to be the user's field of view within the display area of the AR device 201. The external object may include an object existing in the real space. According to various embodiments, the display area where the AR device 201 displays the virtual object may include a portion of the display module (e.g., at least a portion of the display panel). According to an embodiment, the display area may be an area corresponding to at least a portion of the first glass 220 and/or the second glass 230.

According to an embodiment, the AR device 201 may include an imaging camera 213 (e.g., an RGB camera) for capturing an image corresponding to the user's field of view (FoV) and/or measuring the distance to an object, an eye-tracking camera 212 for identifying the direction of the user's gaze, and/or recognition cameras 211-1 and 211-2 (e.g., gesture cameras) for recognizing a predetermined space. According to an embodiment, the AR device 201 may use the imaging camera 213 to measure the distance to an object located in front of the AR device 201. According to an embodiment, the AR device 201 may have multiple eye-tracking cameras 212 disposed to correspond to the user's eyes. For example, the eye-tracking camera 212 may capture an image in a direction opposite to the imaging direction of the imaging camera 213. The eye-tracking cameras 212 may detect the user's gaze direction (e.g., eye movement). For example, the eye-tracking cameras 212 may include a first eye-tracking camera 212-1 for tracking the gaze direction of the user's left eye, and a second eye-tracking camera 212-2 for tracking the gaze direction of the user's right eye. According to an embodiment, the AR device 201 may detect a user gesture within a predetermined distance (e.g., the predetermined space) by using the recognition cameras 211-1 and 211-2. For example, multiple recognition cameras 211-1 and 211-2 may be configured, and may be disposed on both side surface of the AR device 201. The AR device 201 may detect, using at least one camera, the eye corresponding to a dominant eye and/or a non-dominant eye among the left eye and/or right eye. For example, the AR device 201 may detect the eye corresponding to the dominant eye and/or the non-dominant eye, based on the user's gaze direction toward an external object or a virtual object.

According to an embodiment, the imaging camera 213 may include a camera with high resolution, such as a high resolution (HR) camera and/or a photo video (PV) camera. According to an embodiment, the eye-tracking cameras 212 may detect the user's pupil to track the gaze direction, and may be utilized to move the center of the virtual image in response to the gaze direction. For example, the eye-tracking cameras 212 may be divided into the first eye-tracking camera 212-1 corresponding to the left eye and the second eye-tracking camera 212-2 corresponding to the right eye, and the performance and/or specifications of the cameras may be substantially identical. According to an embodiment, the recognition cameras 211-1 and 211-2 may be used for detecting the user's hand (gestures) and/or spatial recognition and may include a global shutter (GS) camera. For example, the recognition cameras 211-1 and 211-2 may include a rolling shutter (RS) camera or a global shutter (GS) camera with low motion blur to detect and track a rapid hand movement and/or a fine movement of a finger or the like.

According to an embodiment, the AR device 201 may display virtual objects related to augmented reality services together, based on the image information related to the real space acquired through the camera (e.g., the imaging camera 213) of the AR device 201. According to an embodiment, the AR device 201 may display the virtual object, based on a display module (e.g., the first display module 220 corresponding to the left eye and/or the second display module 230 corresponding to the right eye) arranged to correspond to the user's eyes. According to an embodiment, the AR device 201 may display the virtual object, based on predetermined configuration information (e.g., resolution, frame rate, brightness, and/or display area).

According to an embodiment, the AR device 201 may operate a first display panel included in the first glass 220 and a second display panel included in the second glass 230 as independent components. For example, the AR device 201 may determine the display performance of the first display panel based on first configuration information and determine the display performance of the second display panel based on second configuration information.

The number and position of at least one camera (e.g., the imaging camera 213, the eye-tracking camera 212, and/or the recognition cameras 211-1 and 211-2) included in the AR device 201 illustrated in FIGS. 2A, 2B, and/or 2C may not be limited. For example, the number and position of at least one camera (e.g., the imaging camera 213, the eye-tracking camera 212, and/or the recognition cameras 211-1 and 211-2) may vary based on the form (e.g., shape or size) of the AR device 201.

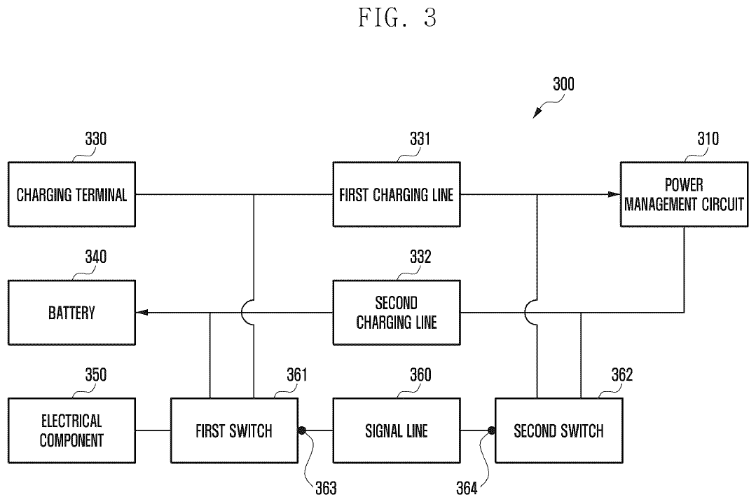

FIG. 3 is a block diagram of an electronic device 300 according to various embodiments (e.g., the electronic device 101 in FIG. 1 or the electronic device 201 in FIGS. 2A, 2B, or 2C). The electronic device 300 may include an augmented reality (AR) device, a virtual reality (VR) device, a mixed reality (MR) device, and an extended reality (XR) device.

Referring to FIG. 3, the electronic device 300 may be in the form of glasses that may be worn by a user, as exemplified in FIGS. 2A to 2C. However, this is merely one example, and the electronic device 300 is not limited thereto, and may be various forms of head-mounted devices (HMD), head-mounted displays (HMDs), or AR glasses.

According to an embodiment, the electronic device 300 may be implemented as a wearable electronic device, and may refer to a head-mounted device or head-mounted display that is worn on the user's head. However, the electronic device 300 may also be configured in the form of at least one of glasses, goggles, a helmet, or a hat. The wearable electronic device 300 may include an optical see-through (OST) type, which is configured so that, when worn, external light reaches the user's eyes through glass, or a video see-through (VST) type, which is configured so that, when worn, light emitted from a display reaches the user's eyes while external light is blocked so as not to reach the user's eyes.

According to an embodiment, the electronic device 300 may include a power management circuit 310 (e.g., the power management module 188 in FIG. 1), a charging terminal 330, a battery 340 (e.g., the battery 189 in FIG. 1), and an electrical component 350.

According to an embodiment, the charging terminal 330 may include terminals supporting various charging methods, such as a pogo pin pad of a pogo pin type, a USB, and a USB Type-C terminal.

According to an embodiment, the power management circuit 310 may manage the power supplied to the electronic device 300.

According to an embodiment, the power management circuit 310 may include a power management integrated circuit (PMIC), a direct charger, an overvoltage protection (OVP), a power delivery integrated circuit (PDIC), and/or multiple switches for converting power charging to a USB Type-C type or a pogo pin type.

According to an embodiment, the power management circuit 310 may receive power supplied from the charging terminal 330 via a first charging line 331 and may provide the supplied power to the battery 340 via a second charging line 332. For example, the first charging line 331 and/or the second charging line may be at least partially disposed in a connector (e.g., the support 221 or 222 in FIG. 2A, 2B, or 2C) which may perform a supporting role of fixing the electronic device 300 to the user's head or ear.

According to an embodiment, the battery 340 may supply power to at least one element of the electronic device 300. According to an embodiment, the battery 340 may include, for example, a non-rechargeable primary battery, a rechargeable secondary battery, or a fuel cell. Here, the battery 340 is implemented as being embedded in the electronic device 300. However, this is one example, and the battery 340 may be implemented as a removable or external battery.

According to an embodiment, the electrical component 350 may include one or more various electrical components included in the electronic device 300, and may include various elements, for example, a camera, a speaker, or a sensor. The number of electrical components 350 is not limited and at least one electrical component may be included.

According to an embodiment, the electrical component 350 may include a signal line 360 for operation thereof. For example, the signal line 360 may include a wire or a flexible printed circuit board (FPCB) connecting the electrical component 350 to a specific point on a printed circuit board. For example, at least a portion of the signal line 360 may be disposed on the support.

According to an embodiment, a first switch 361 for switching the electrical component 350 and the first charging line 331 or the second charging line 332 may be disposed at a first end 363 of the signal line 360. For example, depending on the switching operation of the first switch 361, the signal line 360 may function as a charging line that supplies power from the charging terminal 330 to the power management circuit 310 together with the first charging line 331, or may function as a signal line for operation of the electrical component 350, independently of the first charging line 331. For example, depending on the switching operation of the first switch 361, the signal line 360 may function as a charging line that provides power from the power management circuit 310 to the battery 340 together with the second charging line 332, or may function as a signal line for the operation of the electrical component 350, independently of the second charging line 332.

According to an embodiment, a second switch 362 for switching the electrical component 350 and the first charging line 331 or the second charging line 332 may be disposed at a second end 364 of the signal line 360 (e.g., an opposite end of the signal line 360). For example, depending on the switching operation of the second switch 362, the signal line 360 may function as a charging line that supplies power from the charging terminal 330 to the power management circuit 310 together with the first charging line 331, or may function as a signal line for operation of the electrical component 350. For example, depending on the switching operation of the second switch 362, the signal line 360 may function as a charging line that provides power from the power management circuit 310 to the battery 340 together with the second charging line 332, or may function as a signal line for the operation of the electrical component 350.

According to an embodiment, a processor (e.g., the processor 120 in FIG. 1) may control the first switch 361 and the second switch 362 based on the operating state of the electronic device 300. For example, the switch states of the first and second switches 361 and 362 can cause the signal line 360 of the electrical component 350 to operate as an additional charging line or to operate as the signal line 360 of the electrical component 350.

According to an embodiment, the operating state of the electronic device 300 may include whether the electronic device 300 is in use (e.g., an active state). When the electronic device 300 is determined to be not in use (e.g., an idle state), the processor 120 may control the first switch 361 and the second switch 362 to cause the signal line 360 of the electrical component 350 to operate as an additional charging line. For example, the electronic device 300 may be determined to be not in use when electronic device 300 is in an idle (e.g., sleep) state. For example, the processor (e.g., the processor 120 in FIG. 1) may determine that the electronic device 300 is in use (e.g., an active state) when the electronic device 300 is turned on and operates in an active state. For example, the active state of the electronic device 300 may include a state in which the electronic device 300 performs a designated operation, and may include, for example, a state in which the processor 120 is activated and operates, or a state in which critical functions, such as a display function, are performed.

According to an embodiment, the operating state of the electronic device 300 may include whether the electronic device 300 is worn. When the electronic device 300 is determined to be un-worn, the processor 120 may control the first switch 361 and the second switch 362 to connect the signal line 360 of the electrical component 350 to the charging line 331 or 332, thereby causing the signal line 360 to operate as an additional charging line. For example, the processor 120 may determine whether the electronic device 300 is worn, based on sensor values from various sensors such as a sensor (e.g., the gyro sensor or the accelerometer in the sensor module 176 in FIG. 1), an eye-tracking camera (e.g., the eye-tracking camera 212 in FIG. 2A, 2B, or 2C), or a touch sensor.

According to an embodiment, the operating state of the electronic device 300 may include an operating mode of at least one electrical component 350. The processor 120 may control the operation of the at least one electrical component 350 of the electronic device 300 via a signal (e.g., a turn-on or turn-off signal), and accordingly, the processor 120 may identify the operating state (e.g., turn-on or turn-off) of the at least one electrical component 350. When the at least one electrical component 350 is determined to be in a non-operating state, the processor 120 may control the first switch 361 and the second switch 362 to cause the signal line 360 of the electrical component 350 to operate as an additional charging line. When the at least one electrical component 350 is, for example, a speaker (e.g., the sound output module 155 in FIG. 1), the processor 120 may identify whether the speaker is operating and, if the speaker is off, may cause the speaker's signal line to operate as an additional charging line. When the at least one electrical component 350 of the electronic device 300 is determined to be in an operating state, the processor 120 may switch at least some of the at least one electrical component 350 to an inactive state (e.g., turned off), and control the first switch 361 and the second switch 362 to cause the signal line 360 of the electrical component 350 to operate as an additional charging line. For example, in the case of speakers, the processor 120 may identify whether the speakers are operating. When the speakers are on, the processor 120 may turn off one of the speakers (e.g., either the left or the right stereo speaker) and cause a signal line of that speaker to operate as an additional charging line. For example, when it is identified that the at least one electrical component 350 is activated and operating, the processor 120 may change the operating mode of the at least one electrical component 350 to an off state and cause the signal line 360 of the electrical component 350 to operate as an additional charging line to supply power to the battery 340.

According to an embodiment, the operating state of the electronic device 300 may include a state in which the charging terminal of the electronic device 300 is connected to, for example, a charger (e.g., a docking station) and charging is being performed. The processor 120 may identify whether the charging terminal 330 of the electronic device 300 is mounted to the charger (e.g., the docking station). For example, if the charging terminal 330 is implemented as a pogo pin type, the processor 120 may identify that the charging terminal 330 is mounted to the charger when the pad of the pogo pins of the charging terminal 330 is electrically connected to the pogo pins of the charger. For example, when the charging terminal 330 is mounted to the charger, the processor 120 may cause the signal line 360 of the electrical component 350 to operate as an additional charging line, thereby supplying power to the battery 340.

FIGS. 4A, 4B, and 4C illustrate examples of charging wiring for an electronic device (e.g., the electronic device 101 in FIG. 1, the electronic device 201 in FIGS. 2A, 2B, and 2C, and/or the electronic device 300 in FIG. 3) according to various embodiments.

According to an embodiment, an electronic device 400 may include a first housing 410 (e.g., the body 223 in FIG. 2A, 2B, or 2C) and a second housing 420 (e.g., the support 221 and/or 222 in FIG. 2A, 2B or 2C). The first housing 410 and the second housing 420 may be connected by a connector 430 (e.g., another portion of the support 221 and/or 222 connecting the body 223 and a portion of the support 221 and/or 222 in FIG. 2A, 2B, or 2C) to cause the electronic device to be supported on a user's head or ear. The illustrated connector 430 is an example, and the form and designation of the connector 430 are not limited thereto, and the connector 430 may include various materials or structures. For example, one end of the connector 430 may form an integral structure with the second housing (e.g., a portion to which the battery 233-1 or 233-2 in FIG. 2A, 2B, or 2C is mounted), as illustrated in FIG. 2A, 2B, or 2C. For example, one end of the connector 430 may form an integral structure as a portion of the first housing 410, while the other end thereof may form an integral structure as a portion of the second housing 420, and the ends may be connected via a detachable structure.

Referring to FIG. 4A, a battery 340 and at least one electrical component (e.g., the electrical component 350 in FIG. 3) may be disposed in the second housing 420, while a power management circuit 310 and a charging terminal 330 may be disposed in the first housing 410. As the power management circuit 310 and the charging terminal 330 are disposed in the first housing 410, a first charging line (e.g., the first charging line 331 in FIG. 3) that delivers power from the charging terminal 330 to the power management circuit 310 may be disposed in the first housing 410. For example, a second charging line (e.g., the second charging line 332 in FIG. 3), which supplies power from the power management circuit 310 to the battery 340, and a signal line 360 of the electrical component 350 may be disposed in the connector 430.

According to an embodiment, the processor 120 may identify the operating state (e.g., turned on or turned off) of the at least one electrical component 350. When it is determined that the at least one electrical component 350 are in a non-operating state, the processor 120 may cause the signal line 360 of the electrical component 350 to operate as an additional charging line together with the second charging line 332.

Referring to FIG. 4B, a battery 340, at least one electrical component (e.g., the electrical component 350 in FIG. 3), and a charging terminal 330 may be disposed in the second housing 420, and a power management circuit 310 may be disposed in the first housing 410. For example, a first charging line (e.g., the first charging line 331 in FIG. 3) for supplying power from the charging terminal 330 to the power management circuit 310, a second charging line (e.g., the second charging line 332 in FIG. 3) for supplying power from the power management circuit 310 to the battery 340, and a signal line 360 of the electrical component 350 may be disposed in the connector 430.

According to an embodiment, the processor 120 may identify the operating state (e.g., turned on or turned off) of the at least one electrical component 350. When it is determined that the at least one electrical component 350 is in a non-operating state, the processor may cause the signal line 360 of the electrical component 350 to operate as an additional charging line together with the second charging line 332.

Referring to FIG. 4C, a charging terminal 330 and at least one electrical component (e.g., the electrical component 350 in FIG. 3) may be disposed in the second housing 420, and a power management circuit 310 and a battery 340 may be disposed in the first housing 410. For example, a first charging line 331 for supplying power from the charging terminal 330 to the power management circuit 310 and a signal line 360 of the electrical component 350 may be disposed in the connector 430.

According to an embodiment, the processor 120 may identify the operating state (e.g., turned on or turned off) of the at least one electrical component 350. When it is determined that the at least one electrical component 350 is in a non-operating state, the processor 120 may cause the signal line 360 of the electrical component 350 to operate as an additional charging line together with the first charging line 331.

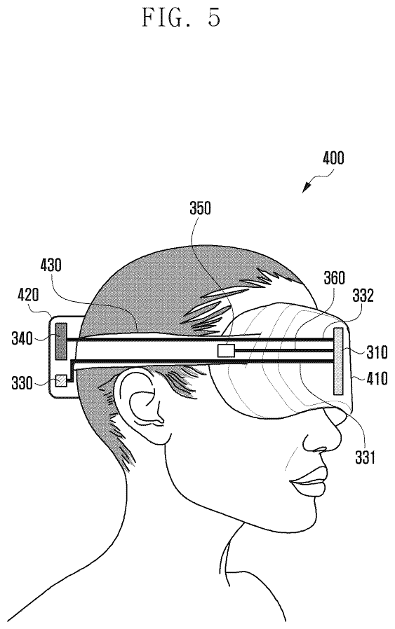

FIG. 5 illustrates an example of charging wiring for an electronic device (e.g., the electronic device 101 in FIG. 1, the electronic device 201 in FIG. 2A, 2B, or 2C, and/or the electronic device 300 in FIG. 3) according to an embodiment.

According to an embodiment, an electronic device 400 may include a first housing 410 (e.g., the body 223 in FIG. 2A, 2B, or 2C) and a second housing 420 (e.g., a portion of the support 221 and/or 222 in FIG. 2A, 2B, or 2C). The first housing 410 and the second housing 420 may be connected by a connector 430 (e.g., another portion of the support 221 and/or 222 connecting the body 223 and a portion of the support 221 and/or 222 in FIG. 2A, 2B, or 2C), thereby causing the electronic device to be supported on a user's head or ear.

Referring to FIG. 5, the at least one electrical component (e.g., the electrical component 350 in FIG. 3), such as a speaker, may be disposed in a connector 430. Accordingly, a signal line 360 of the electrical component 350 may be disposed in the connector 430.

In FIG. 5, the arrangement of other components, except for the position of the at least one electrical component 350, may be implemented according to the layout structure in one of FIG. 4A, FIG. 4B, or FIG. 4C. For example, as illustrated in FIG. 4A, a battery 340 may be disposed in the second housing 420, while a power management circuit 310 and a charging terminal 330 may be disposed in the first housing 410. For example, as illustrated in FIG. 4B, the battery 340 and the charging terminal 330 may be placed in the second housing 420, while the power management circuit 310 may be placed in the first housing 410. For example, as illustrated in FIG. 4C, the charging terminal 330 may be disposed in the second housing 420, while the power management circuit 310 and the battery 340 may be disposed in the first housing 410.

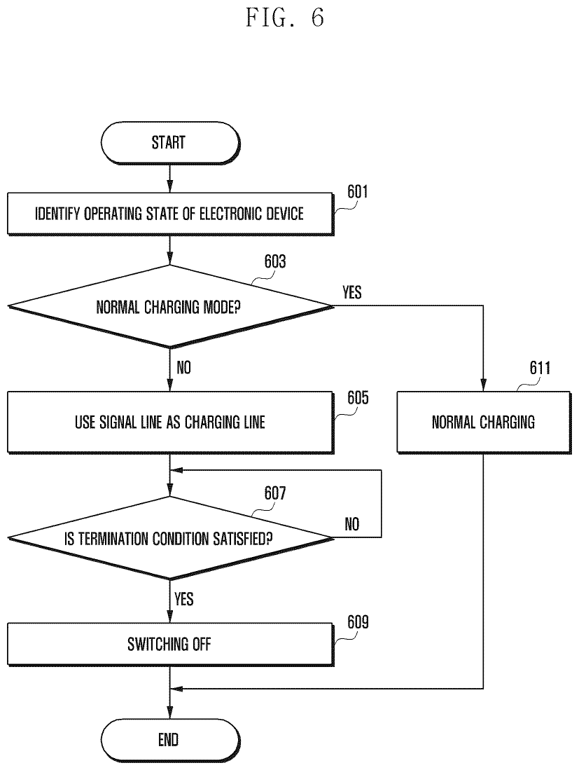

FIG. 6 is a flowchart illustrating an operation in which an electronic device (e.g., the electronic device 101 in FIG. 1, the electronic device 201 in FIGS. 2A, 2B, and 2C, the electronic device 300 in FIG. 3, or the electronic device 400 in FIG. 4A, FIG. 4B, FIG. 4C, and/or FIG. 5) according to various embodiments charges a battery (e.g., the battery 340 in FIG. 3) via a power management circuit (e.g., the power management circuit 310 in FIG. 3).

According to an embodiment, as charging begins, a processor (e.g., the processor 120 in FIG. 1) of the electronic device may identify the operating state of the electronic device in operation 601. For example, charging may begin as power is supplied through a charging terminal (e.g., the charging terminal 330 in FIG. 3).

According to an embodiment, the operating state of the electronic device may include whether the electronic device is in use. For example, when the electronic device is turned on and operating in an active state, the processor may determine that the electronic device is in use. For example, when the electronic device is in an idle state (e.g., sleep state), the processor may determine that the electronic device is not in use.

According to an embodiment, the operating state of the electronic device may include whether the electronic device is worn. For example, the processor may determine whether the electronic device is worn, based on sensor values from various sensors such as a gyro sensor, an accelerometer, an eye-tracking camera, or a touch sensor.

According to an embodiment, the operating state of the electronic device may include the operating mode of at least one electrical component. For example, the at least one electrical component may include two speakers, and the speakers operating in a stereo mode may be switched to a mono mode, wherein a signal line of the speaker that has stopped operating among the two speakers may be used as a charging line.

According to an embodiment, the operating state of the electronic device may include a state in which the charging terminal of the electronic device is connected to, for example, a charger (e.g., a docking station) and charging is performed.

According to an embodiment, in operation 603, the processor may determine whether to proceed with the charging mode of the electronic device as a normal charging mode.

According to an embodiment, the processor may determine the charging mode based on the operating state of the electronic device. For example, the processor may determine to perform a first mode (e.g., an active charging mode) according to an embodiment when the electronic device is in an idle (e.g., a sleep state), and to perform a second mode (e.g., a normal charging mode) when the electronic device is in an active state. For example, the active charging mode may include a charging mode in which battery charging is performed using a signal line of the at least one electrical component as an additional charging line in addition to the existing charging line, as described above. For example, the normal charging mode may include a charging mode in which charging is performed only through the charging line by using a signal line of the at least one electrical component as a normal signal line. For example, even when the electronic device is not in an idle state, if at least one electrical component is in an unused state (e.g., function OFF) or is switched to a turned-off or inactive state when in use, the charging mode may be switched to the above-described active charging mode according to an embodiment. For example, when the electronic device is not in a worn state, the processor may determine to perform the active charging mode according to an embodiment. For example, when the charging terminal of the electronic device is connected to, for example, a charger (e.g., a docking station) and charging is being performed, the processor may determine to perform the active charging mode according to an embodiment.

According to an embodiment, the processor may determine the charging mode based on the battery charge level of the electronic device. For example, the processor may identify the start condition of the active charging mode, based on a configured battery charge level (e.g., 20% or 30%). For example, the processor may determine that the active charging mode may be performed when the battery charge level through the power management circuit is below a certain level (e.g., below 20% or 30%).

According to an embodiment, the processor may perform battery charging according to the active charging mode by switching a signal line of the at least one electrical component to a charging line and using the signal line as an additional charging line in addition to the existing charging line, as described in operation 605.

According to an embodiment, the processor may perform battery charging according to the active charging mode by using a signal line of the at least one electrical component as an additional charging line, as described in operation 605, and using the signal line as an additional charging line in addition to the existing charging line.

According to an embodiment, the processor may perform a switching operation to use the signal line of the at least one electrical component as a charging line.

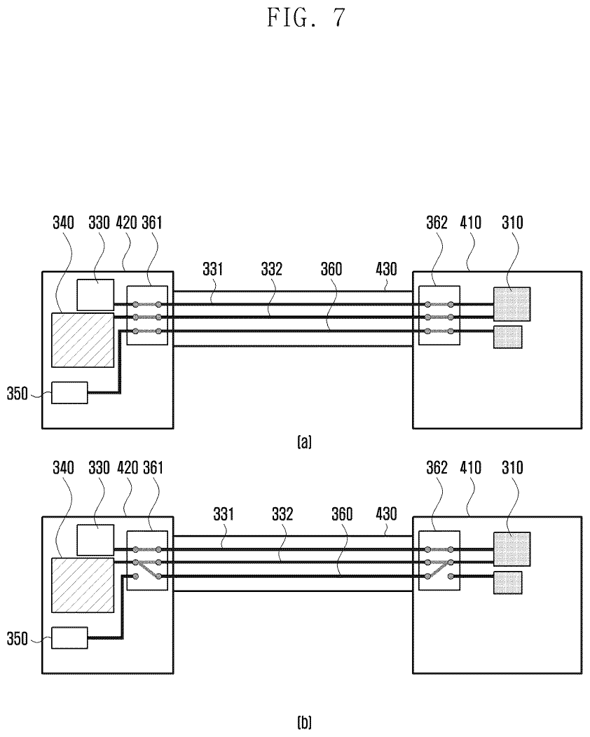

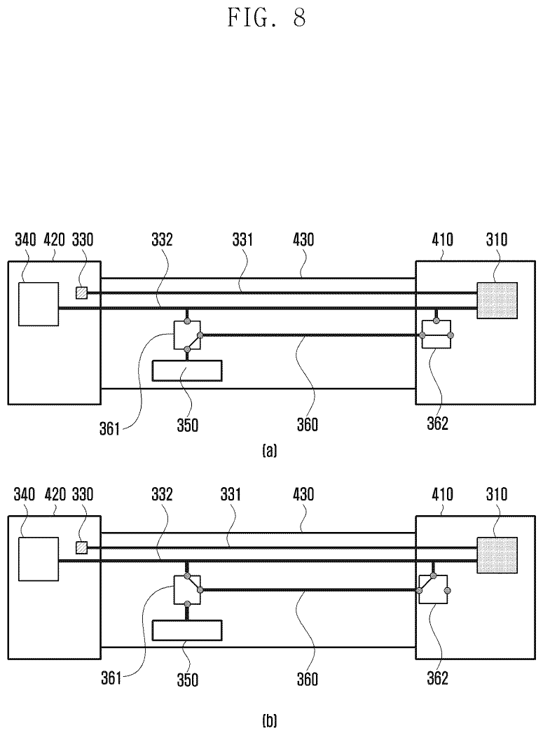

FIGS. 7 and 8 illustrate examples of a switching operation according to an active charging operation of an electronic device (e.g., the electronic device 101 in FIG. 1, the electronic device 201 in FIG. 2A, 2B, or 2C, the electronic device 300 in FIG. 3, or the electronic device 400 in FIGS. 4A, 4B, 4C, and/or 5) according to an embodiment.

Referring to FIG. 7A or 8A, a power management circuit (e.g., the power management circuit 310 in FIG. 3) may receive power from a charging terminal 330 via a first charging line (e.g., the first charging line 331 in FIG. 3) and may provide the supplied power to a battery 340 via a second charging line (e.g., the second charging line 332 in FIG. 3). For example, the first charging line 331 and/or the second charging line 332 may be at least partially disposed in a connector 430 (e.g., the support 221 or 222 in FIG. 2A, 2B, or 2C or the connector 430 in FIG. 4A, 4B, 4C, or 5) which may perform a supporting role of fixing the electronic device 300 to a user's head or ear.

According to an embodiment, an electrical component 350 may be positioned within a second housing 420 as illustrated in FIG. 7, or positioned on the connector 430 as illustrated in FIG. 8.

According to an embodiment, the electrical component 350 may include a signal line (e.g., the signal line 360 in FIG. 3, 4A, 4B, 4C, or 5) for the operation thereof. For example, the signal line 360 may include a wire connecting the electrical component 350 to the processor 120 or a specific point on the printed circuit board. For example, at least a portion of the signal line 360 may be disposed on the support.

According to an embodiment, a first switch 361 for switching the electrical component 350 and the first charging line 331 or the second charging line 332 may be disposed at a first end (e.g., the first end 363 in FIG. 3) of the signal line 360. For example, depending on the switching operation of the first switch 361, the signal line 360 may function as a charging line for supplying charging power from the charging terminal 330 together with the first charging line 331 or the second charging line 332, or may function as a signal line for the operation of the electrical component 350.

According to an embodiment, the second switch 362 for switching the electrical component 350 and the first charging line 331 or the second charging line 332 may be disposed at a second end (e.g., the second end 364 in FIG. 3) of the signal line 360. For example, depending on the switching operation of the second switch 362, the signal line 360 may function as a charging line for supplying charging power, or may function as a signal line for the operation of the electrical component 350.

According to an embodiment, as illustrated in FIG. 7B or FIG. 8B, the processor may, in response to the switching operation of the signal line 360 of at least one electrical component 350, switch the first switch 361 to the second charging line 332 and switch the second switch 362 to a second charging line 332, thereby enabling the signal line 360 to be used as a charging line that supplies power from the power management circuit 310 to the battery 340, together with the second charging line 332.

In the example in FIG. 8B where the at least one electrical component 350, such as a speaker, is positioned on the connector 430, when charging is performed using the signal line 360 of the electrical component 350 as an additional charging line according to an active charging mode, the resistance (e.g., direct current resistance) of the charging line may be improved.

For example, charging is performed according to the active charging mode, and the signal line 360 may be switched to a charging line (e.g., the second charging line 332), and thus wires can be combined. Accordingly, the resistance (direct current resistance (DCR)) of the charging line (e.g., the second charging line 332 and the signal line 360) may decrease, for example, from approximately 70 mΩ to approximately 40 mΩ, by approximately 30 mΩ, due to the wire extension. As a result, energy efficiency may be increased and thus charging time may be shortened.

According to an embodiment, as the resistance is reduced and energy efficiency is increased, charging time may be shortened. For example, when charging time is approximately 84 minutes at a resistance of approximately 70 mΩ, if the signal line additionally functions as a charging line according to the active charging mode and thus the resistance is reduced to approximately 40 mΩ, the charging time may be shortened to approximately 80 minutes.

According to an embodiment, FIG. 7B or 8B are examples. The processor may, according to the switching operation of the signal line 360 of the at least one electrical component 350, switch the first switch 361 to the first charging line 331 and switch the second switch 362 to the first charging line 331, thereby enabling the signal line 360 to be used as a charging line that supplies power from the charging terminal 330 to the power management circuit 310, together with the first charging line 331.

Referring again to FIG. 6, according to an embodiment, the processor may identify, in operation 607, whether the termination condition of the active charging mode has been satisfied. For example, the processor may identify whether the charging mode termination condition has been satisfied, based on a battery charge level, a charging voltage, or a charging current. For example, the processor may identify the termination condition of the active charging mode, based on a configured battery charge level (e.g., 80% or 100%), charge voltage, or charge current. For example, the processor may terminate the active charging mode when the battery charge level is equal to or higher than a certain level (e.g., above 80%) through the power management circuit, when the charging current condition, such as a charging current characteristic, exceeds a certain section (e.g., constant current), when a certain section (e.g., step section) is exceeded during step charging, or when the charging voltage condition, such as the charging voltage, is equal to or higher than a certain level. For example, in operation 607, when it is identified that the termination condition of the active charging mode is not satisfied, the processor may continuously monitor whether the termination condition is satisfied.

For example, the processor may identify whether the charging mode termination condition is satisfied, based on receiving a user input. For example, when a user input occurs for the operation of at least one electrical component, the processor may terminate the active charging mode.

According to an embodiment, in operation 609, when termination of the active charging mode is determined, the processor may turn off the switching to block the power supplied through the signal line. Accordingly, the signal line of the at least one electrical component may operate as a signal line.

According to an embodiment, for the signal line 360 of the at least one electrical component 350, the processor may control the first switch 361 and the second switch 362 to disconnect the signal line 360 from the charging line, thereby preventing power from being supplied through the signal line 360, and providing a signal through the signal line 360 to operate the at least one electrical component.

According to an embodiment, when it is determined, in operation 603, that the charging mode of the electronic device proceeds to the normal charging mode, the processor may proceed to operation 611 to charge the electronic device in the normal charging mode.

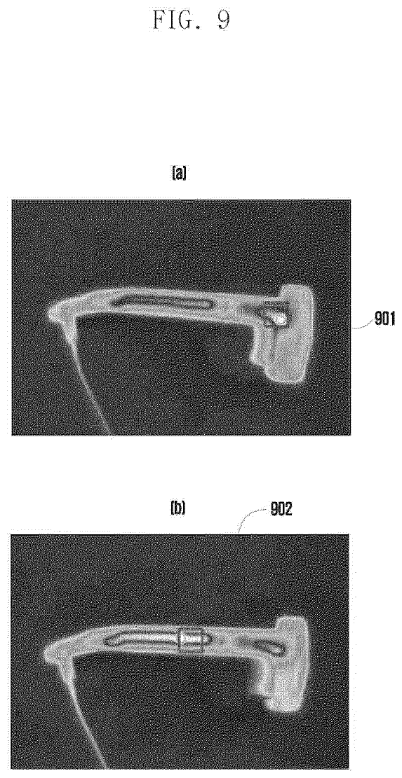

FIG. 9 illustrates a heat generation phenomenon according to the charging operation of an electronic device in various embodiments.

According to an embodiment, under high-power charging (25 W) conditions, FIG. 9A may illustrate an example of charging only through a charging line according to a normal charging mode, and may exhibit a resistance of approximately 70 mΩ. Accordingly, it can be observed that heat generation of up to approximately 38.8° C. occurs along the charging line near a first housing 901.

According to an embodiment, under the same high-power charging (25 W) conditions as in the normal charging mode, FIG. 9B may illustrate an example of charging using a signal line of at least one electrical component as an additional charging line according to an active charging mode, and it can be observed that the resistance is reduced to approximately 40 mΩ. Accordingly, it can be observed that the heat generation of up to approximately 37.2° C. occurs at the location 902 of the at least one electrical component. Therefore, in the active charging mode, not only a reduction in resistance but also an improvement in heat generation temperature of approximately 1.6° C. may be observed.

According to an embodiment, a head-mounted electronic device (e.g., the electronic device 101 in FIG. 1, the electronic device 201 in FIG. 2A, 2B, or 2C, the electronic device 300 in FIG. 3, or the electronic device 400 in FIGS. 4A, 4B, 4C, and/or 5) may include a battery (e.g., the battery 340 in FIG. 3), a charging terminal (e.g., the charging terminal 330 in FIG. 3), a power management circuit (e.g., the power management circuit 310 in FIG. 3) configured to receive power and charge the battery, a first charging line (e.g., the first charging line 331 in FIG. 3) configured to connect the charging terminal to the power management circuit, a second charging line (e.g., the second charging line 332 in FIG. 3) configured to connect the power management circuit to the battery, a signal line (e.g., the signal line 360 in FIG. 3) of at least one electrical component (e.g., the at least one electrical component 350 in FIG. 3), a first switch (e.g., the first switch 361 in FIG. 3) configured to switch the at least one electrical component and the first charging line or the second charging line at a first end of the signal line, a second switch (e.g., the second switch 362 in FIG. 3) configured to switch the at least one electrical component and the first charging line or the second charging line at a second end of the signal line, and a processor (e.g., the processor 120 in FIG. 1) operatively connected to the power management circuit, the at least one electrical component, the first switch, and the second switch, wherein the processor is configured to switch the first switch and the second switch during charging of the battery to supply power from the charging terminal to the battery via the first charging line or the second charging line and the signal line.

According to an embodiment, the processor may be configured to identify whether the electronic device is in use, and, when the electronic device is not in use, switch the first switch 361 and the second switch 362 to connect the signal line 360 to the first charging line 331 or the second charging line 332 and supply power from the charging terminal to the battery 340 via the first charging line 331, the second charging line 332, and the signal line 360.

According to an embodiment, the processor may be configured to identify whether the electronic device is worn and, when the electronic device is not worn, switch the first switch 361 and the second switch 362 to connect the signal line 360 to the first charging line 331 or the second charging line 332 and supply power from the charging terminal to the battery 340 via the first charging line 331, the second charging line 332, and the signal line 360.

According to an embodiment, the processor may be configured to identify whether the at least one electrical component is in use, and, when the at least one electrical component is not in use, switch the first switch 361 and the second switch 362 to connect the signal line 360 to the first charging line 331 or the second charging line 332 and supply power from the charging terminal 330 to the battery 340 via the first charging line 331, the second charging line 332, and the signal line 360.

According to an embodiment, the processor may be configured to, when the at least one electrical component is in use, change an operating mode of the at least one electrical component, switch the first switch 361 and the second switch 362 to connect the signal line 360 to the first charging line 331 or the second charging line 332, and supply power from the charging terminal 330 to the battery 340 via the first charging line 331, the second charging line 332, and the signal line 360.

According to an embodiment, the processor may be configured to identify whether the charging terminal is mounted to a charger, and, when the charging terminal is mounted to the charger, switch the first switch 361 and the second switch 362 to connect the signal line 360 to the first charging line 331 or the second charging line 332 and supply power from the charging terminal 330 to the battery 340 via the first charging line 331, the second charging line 332, and the signal line 360.

According to an embodiment, the processor may be configured to control the first switch and the second switch based on at least one of the battery's charging level, charging voltage, or charging current, thereby blocking the power supplied to the battery via the signal line.

According to an embodiment, the processor may be configured to receive a user input for the at least one electrical component, and control the first switch and the second switch, based on the user input, to block the power supplied to the battery via the signal line.

According to an embodiment, the electronic device may further include a first housing (e.g., the first housing 410 in FIG. 4A, 4B, or 4C) in which the power management circuit is disposed, and a second housing (e.g., the second housing 420 in FIG. 4A, 4B, or 4C) in which the battery is disposed, and the signal line may be disposed in a connector (e.g., the connector 430 in FIG. 4A, 4B, or 4C) configured to connect the first housing to the second housing.

According to an embodiment, the electronic device may further include a first housing in which the battery and the power management circuit are disposed, and a second housing in which the charging terminal is disposed, and the signal line may be disposed in a connector configured to connect the first housing to the second housing.

According to an embodiment, the at least one electrical component may be disposed in the second housing or the connector.

According to an embodiment, a method for an electronic device including at least one electrical component, a charging terminal, a power management circuit, and a battery may include an operation of identifying an operating state of the electronic device, an operation of determining a charging mode of the electronic device, and an operation of, based on the charging mode, using the signal line as a charging line between the charging terminal, the power management circuit, and the battery to perform charging of the battery via the signal line together with the charging line, or using the signal line as a normal signal line to perform charging via the charging line.

According to an embodiment, the electronic device may include a first switch configured to switch at least one electrical component and the first charging line or the second charging line at a first end of the signal line, and a second switch configured to switch the at least one electrical component and the first charging line or the second charging line at a second end of the signal line, and the method may further include an operation of switching the first switch and the second switch for charging via the signal line.

According to an embodiment, the operating state may include whether the electronic device is in use, and based on the electronic device being not in use, charging of the battery may be performed via the signal line together with the charging line.

According to an embodiment, the operating state may include whether the electronic device is worn, and when the electronic device is not worn, charging of the battery may be performed via the signal line together with the charging line.

According to an embodiment, the operating state may include whether the at least one electrical component is in use, and when the at least one electrical component is in use, an operating mode of the at least one electrical component may be changed, and charging of the battery may be performed via the signal line together with the charging line.

According to an embodiment, the operating state may include whether the electronic device is mounted to a charger, and when the electronic device is mounted to the charger, charging of the battery may be performed via the signal line together with the charging line.

According to an embodiment, the method may further include an operation of blocking the power supplied to the battery via the signal line, based on at least one of the battery's charging level, charging voltage, or charging current.

According to an embodiment, the method may further include an operation of receiving a user input, and an operation of blocking the power supplied to the battery via the signal line, based on the user input.

According to an embodiment, the user input may include a user input for an operation of the at least one electrical component.

The electronic device according to various embodiments set forth herein may be one of various types of electronic devices. The electronic device may include, for example, a portable communication device (e.g., a smart phone), a computer device, a portable multimedia device, a portable medical device, a camera, a wearable device, or a home appliance. The electronic device according to embodiments of the disclosure is not limited to those described above.

It should be appreciated that the embodiments and the terms used therein are not intended to limit the technological features set forth herein to particular embodiments and the disclosure includes various changes, equivalents, or alternatives for a corresponding embodiment. With regard to the description of the drawings, similar reference numerals may be used to designate similar or relevant elements. A singular form of a noun corresponding to an item may include one or more of the items, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one or all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order). If an element (e.g., a first element) is referred to, with or without the term “operatively” or “communicatively”, as “coupled with/to” or “connected with/to” another element (e.g., a second element), it means that the element may be coupled/connected with/to the other element directly (e.g., wiredly), wirelessly, or via a third element.

As used in various embodiments of the disclosure, the term “module” may include a unit implemented in hardware, software, or firmware, and may be interchangeably used with other terms, for example, “logic,” “logic block,” “component,” or “circuit”. The “module” may be a single integrated component, or a minimum unit or part thereof, adapted to perform one or more functions. For example, according to an embodiment, the “module” may be implemented in the form of an application-specific integrated circuit (ASIC).

Various embodiments as set forth herein may be implemented as software (e.g., the program 140) including one or more instructions that are stored in a storage medium (e.g., the internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Herein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, methods according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store TM), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each element (e.g., a module or a program) of the above-described elements may include a single entity or multiple entities, and some of the multiple entities may be separately disposed in another element. According to various embodiments, one or more of the above-described elements or operations may be omitted, or one or more other elements or operations may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

The embodiments of the disclosure set forth herein are merely specific examples that have been presented to easily explain the technical contents of the disclosure and help understanding of the disclosure, and are not intended to limit the scope of the disclosure. Therefore, the scope of various embodiments of the disclosure should be construed to include, in addition to the embodiments set forth herein, all changes and modifications derived based on the technical idea of various embodiments of the disclosure.

1. A head-mounted electronic device comprising:
a battery;
a charging terminal;
a power management circuit configured to receive power input thereto and charge the battery with the power;
a first charging line configured to connect the charging terminal to the power management circuit;
a second charging line configured to connect the power management circuit to the battery;
a signal line of at least one electrical component;
a first switch configured to switch between the at least one electrical component and the first charging line or the second charging line at a first end of the signal line;
a second switch configured to switch between the at least one electrical component and the first charging line or the second charging line at a second end of the signal line; and
a processor operatively connected to the power management circuit, the at least one electrical component, the first switch, and the second switch,
wherein the processor is configured to, during charging of the battery, switch the first switch and the second switch to supply power from the charging terminal to the battery via the first charging line or the second charging line and the signal line.

2. The electronic device of claim 1, wherein the processor is configured to:
identify whether the electronic device is in use; and
in case that the electronic device is not in use, switch the first switch and the second switch to connect the signal line to the first charging line or the second charging line, and supply power from the charging terminal to the battery via the first charging line, the second charging line, and the signal line.

3. The electronic device of claim 1, wherein the processor is configured to:
identify whether the electronic device is worn; and
in case that the electronic device is not worn, switch the first switch and the second switch to connect the signal line to the first charging line or the second charging line, and supply power from the charging terminal to the battery via the first charging line, the second charging line, and the signal line.

4. The electronic device of claim 1, wherein the processor is configured to:
identify whether the at least one electrical component is in use, and
in case that the at least one electrical component is not in use, switch the first switch and the second switch to connect the signal line to the first charging line or the second charging line, and supply power from the charging terminal to the battery via the first charging line, the second charging line, and the signal line.

5. The electronic device of claim 4, wherein the processor is configured to, in case that the at least one electrical component is in use, change an operating mode of the at least one electrical component, switch the first switch and the second switch to connect the signal line to the first charging line or the second charging line, and supply power from the charging terminal to the battery via the first charging line, the second charging line, and the signal line.

6. The electronic device of claim 1, wherein the processor is configured to:
identify whether the charging terminal is mounted to a charger, and
in case that the charging terminal is mounted to the charger, switch the first switch and the second switch to connect the signal line to the first charging line or the second charging line, and supply power from the charging terminal to the battery via the first charging line, the second charging line, and the signal line.

7. The electronic device of claim 1, wherein the processor is configured to, based on at least one of a charging level, charging voltage, or charging current of the battery, control the first switch and the second switch to block the power supplied to the battery via the signal line.

8. The electronic device of claim 1, wherein the processor is configured to:
receive a user input for the at least one electrical component, and
based on the user input, control the first switch and the second switch to block the power supplied to the battery via the signal line.

9. The electronic device of claim 1, further comprising:
a first housing in which the power management circuit is mounted; and
a second housing in which the battery is mounted,
wherein the signal line is disposed in a connector configured to connect the first housing to the second housing.

10. The electronic device of claim 1, further comprising:
a first housing in which the battery and the power management circuit are mounted; and
a second housing in which the charging terminal is mounted,
wherein the signal line is disposed in a connector configured to connect the first housing to the second housing.

11. The electronic device of claim 9, wherein the at least one electrical component is disposed in the second housing or the connector.

12. A method of an electronic device comprising at least one electrical component, a charging terminal, a power management circuit, and a battery, the method comprising:
identifying an operation state of the electronic device;
determining a charging mode of the electronic device; and
based on the charging mode, using a signal line as a charging line between the charging terminal, the power management circuit, and the battery to perform charging of the battery via the signal line together with the charging line, or using the signal line as a normal signal line to perform charging via the charging line.

13. The method of claim 12, wherein the electronic device comprises a first switch configured to switch between the at least one electrical component and the charging line at a first end of the signal line, and a second switch configured to switch between the at least one electrical component and the charging line at a second end of the signal line, and
wherein the method further comprises switching the first switch and the second switch to connect the signal line to the charging line for charging via the signal line.

14. The method of claim 12, wherein the operation state comprises whether the electronic device is in use or whether the electronic device is worn, and
wherein, based on the electronic device being not in use, charging of the battery is performed via the signal line together with the charging line.

15. The method of claim 12, wherein the operation state comprises whether the at least one electrical component is in use, and
in case that the at least one electrical component is in use, an operation mode of the at least one electrical component is changed, and charging of the battery is performed via the signal line together with the charging line.

16. An electronic device, comprising:
a battery;
a charging terminal;
a power management circuit configured to receive power and charge the battery;
a charging circuit configured to deliver power between the charging terminal and the battery;
at least one electrical component connected to a signal line;
a first switch disposed at a first end of the signal line and a second switch disposed at a second end of the signal line opposite the first end; and
a processor connected to the power management circuit, the at least one electrical component, the first switch, and the second switch,
wherein the processor is configured to identify different operating states of the electronic device and, based on an identified operating state, control the first switch and the second switch to selectively connect the signal line to the charging circuit or to the at least one electrical component.

17. The electronic device of claim 16, wherein the signal line is configured to deliver power based on a first switch state of the first and second switches or to deliver a data signal based on a second switch state of the first and second switches.

18. The electronic device of claim 17, wherein the different operating states include an idle state and an active state.

19. The electronic device of claim 18, wherein the processor is configured to control the first and second switches in the first switch state such that the signal line delivers the power to the charging circuit in response to the identified operating state being the idle state.

20. The electronic device of claim 19, wherein the processor is configured to control the first and second switches in the second switch such that the signal line delivers the data signal to the at least one electrical component in response to identified operating state being the active state.
